(19) United States
(12) Patent Application Publication
(10) Pub. No.: US 2024/0349298 A1
(43) Pub. Date: Oct. 17, 2024

(54) METHOD AND USER EQUIPMENT FOR TRANSMISSION CONFIGURATION INDICATION FOR MULTIPLE TRANSMISSION RECEPTION POINTS

(71) Applicant: MEDIATEK INC., Hsinchu City (TW)

(72) Inventor: Cheng-Rung TSAI, Hsinchu City (TW)

(21) Appl. No.: 18/681,585

(22) PCT Filed: Jan. 6, 2023
(86) PCT No.: PCT/CN2023/071048

§ 371 Date: Feb. 6, 2024

Related U.S. Application Data
(60) Provisional application No. 63/297,251, filed on Jan. 7, 2022.
(60) Provisional application No. 63/300,654, filed on Jan. 19, 2022.
(60) Provisional application No. 63/312,119, filed on Feb. 21, 2022.
(60) Provisional application No. 63/324,671, filed on Mar. 29, 2022.
(60) Provisional application No. 63/330,840, filed on Apr. 14, 2022.

(51) Int. Cl. H04W 72/232; H04L 5/00

(52) U.S. Cl. CPC H04W 72/232; H04L 5/0094

(57) ABSTRACT

Method and UE are provided for TCI for multiple TRPs. In particular, a UE can receive a command from a network. The command indicates a plurality of serving TCIs. Then, the UE can receive a DCI from a network. The DCI schedules a downlink reception or an uplink transmission and includes a serving TCI indicator. The UE can apply at least one of the serving TCIs to the downlink reception or the uplink transmission according to the serving TCI indicator in the DCI.

### CROSS REFERENCE TO RELATED APPLICATIONS

This application claims the benefit under 35 U.S.C. § 119 from U.S. provisional application Ser. No. 63/297,251, entitled “Unified TCI Framework for MTRP Operation,” filed on Jan. 7, 2022; U.S. Provisional Application No. 63/300,654, entitled “Unified Transmission Configuration Indication (TCI) Framework for Multiple Transmission Reception Points (MTRP) Operation,” filed on Jan. 19, 2022; U.S. Provisional Application No. 63/312,119, entitled “Unified Transmission Configuration Indication (TCI) Framework for Multiple Transmission Reception Points (MTRP) Operation,” filed on Feb. 21, 2022; U.S. Provisional Application No. 63/324,671, entitled “Unified Transmission Configuration Indication (TCI) Framework for Multiple Transmission Reception Points (MTRP) Operation,” filed on Mar. 29, 2022; U.S. Provisional Application No. 63/330,840, entitled “Unified Transmission Configuration Indication (TCI) Framework for Multiple Transmission Reception Points (MTRP) Operation,” filed on Apr. 14, 2022, the subject matter of which is incorporated herein by reference.

### TECHNICAL FIELD

The disclosed embodiments relate generally to wireless communication, and, more particularly, to method and user equipment for transmission configuration indication (TCI) for multiple transmission reception points (TRPs).

### BACKGROUND

In conventional network of 3rd generation partnership project (3GPP) 5G new radio (NR), the user equipment (UE) can be configured, by the network, with control resource sets (CORESETs), search space sets and transmission configuration indication (TCI) states. The UE can apply one or more TCI states for downlink reception and uplink transmission with a transmission reception point (TRP). In some scenarios, the UE may need to communicate with multiple TRPs. However, some details of applying the TCI states for multiple TRPs have not been determined and need to be further discussed.

### SUMMARY

Method and user equipment (UE) are provided for transmission configuration indication (TCI) for multiple transmission reception points (TRPs). In particular, a UE can receive a command from a network. The command indicates a plurality of serving TCIs. Then, the UE can receive a downlink control information (DCI) from a network. The DCI schedules a downlink reception or an uplink transmission and includes a serving TCI indicator. The UE can apply at least one of the serving TCIs to the downlink reception or the uplink transmission according to the serving TCI indicator in the DCI.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting TCI for multiple TRPs in accordance with embodiments of the current invention.

FIG. 2 is a simplified block diagram of the TRP and the UE in accordance with embodiments of the current invention.

FIG. 3 illustrates one embodiment of message transmissions in accordance with embodiments of the current invention.

FIG. 4A illustrates an example of TCI states in accordance with embodiments of the current invention.

FIG. 4B illustrates an example of TCI states in accordance with embodiments of the current invention.

FIG. 5 illustrates one embodiment of message transmissions in accordance with embodiments of the current invention.

FIG. 6A illustrates an example of associations between serving TCIs and CORESETs in accordance with embodiments of the current invention.

FIG. 6B illustrates an example of associations between serving TCIs and CORESETs in accordance with embodiments of the current invention.

FIG. 6C illustrates an example of associations between serving TCIs and CORESETs in accordance with embodiments of the current invention.

FIG. 7 illustrates one embodiment of message transmissions in accordance with embodiments of the current invention.

FIG. 8 is a flow chart of a method for TCI for multiple-TRPs in accordance with embodiments of the current invention.

FIG. 9 is a flow chart of a method for TCI for multiple-TRPs in accordance with embodiments of the current invention.

FIG. 10 is a flow chart of a method for TCI for multiple-TRPs in accordance with embodiments of the current invention.

### DETAILED DESCRIPTION

Reference will now be made in detail to some embodiments of the invention, examples of which are illustrated in the accompanying drawings.

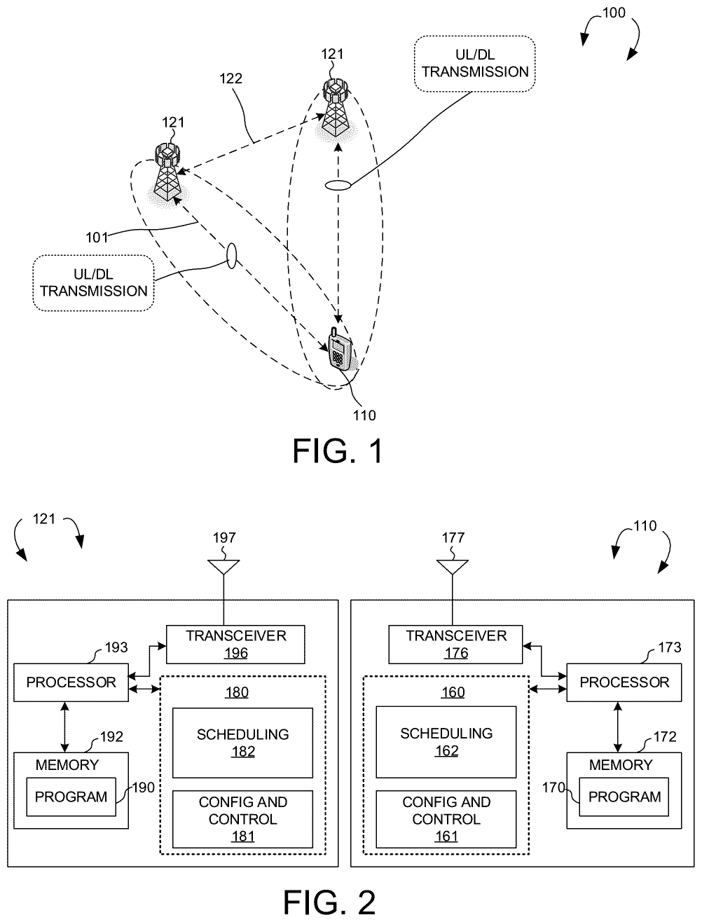

FIG. 1 illustrates an exemplary 5G new radio (NR) network 100 supporting transmission configuration indication (TCI) for multiple transmission reception points (TRPs) in accordance with aspects of the current invention. The 5G NR network 100 includes a user equipment (UE) 110 communicatively connected to a plurality TRPs 121.

Each TRP 121 may provide radio access using a Radio Access Technology (RAT) (e.g., the 5G NR technology). The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

Each TRP 121 may provide communication coverage for a geographic coverage area in which communications with the UE 110 is supported via a communication link 101. The communication links 101 shown in the 5G NR network 100 may respectively include uplink (UL) transmissions from the UE 110 to the TRPs 121 (e.g., on the Physical Uplink Control Channel (PUCCH) or Physical Uplink Shared Channel (PUSCH)) or downlink (DL) transmissions from the TRPs 121 to the UE 110 (e.g., on the Physical Downlink Control Channel (PDCCH) or Physical Downlink Shared Channel (PDSCH)). The TRPs 121 may communicate with each other via a communication link 122.

FIG. 2 is a simplified block diagram of one TRP 121 and the UE 110 in accordance with embodiments of the present invention. For the TRP 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the TRP 121. Memory 192 stores program instructions and data 190 to control the operations of the TRP 121.

Similarly, for the UE 110, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 110. Memory 172 stores program instructions and data 170 to control the operations of the UE 110. Although a specific number of transceiver 176 and antenna 177 are depicted in FIG. 2, it is contemplated that any number of transceiver 176 and antenna 177 may be included in the UE 110 for communicating with multiple TRPs 121 simultaneously.

The TRP 121 and the UE 110 also include several functional modules and circuits that can be implemented and configured to perform embodiments of the present invention. In the example of FIG. 2, the TRP 121 includes a set of control functional modules and circuit 180. TCI handling circuit 182 handles TCI for multiple TRPs and associated network parameters for the UE 110. Configuration and control circuit 181 provides different parameters to configure and control the UE 110. The UE 110 includes a set of control functional modules and circuit 160. TCI handling circuit 162 handles TCI for multiple TRPs and associated network parameters. Configuration and control circuit 161 handles configuration and control parameters from the TRPs 121.

Note that the different functional modules and circuits can be implemented and configured by software, firmware, hardware, and any combination thereof. The function modules and circuits, when executed by the processors 193 and 173 (e.g., via executing program codes 190 and 170), allow the TRPs 121 and the UE 110 to perform embodiments of the present invention.

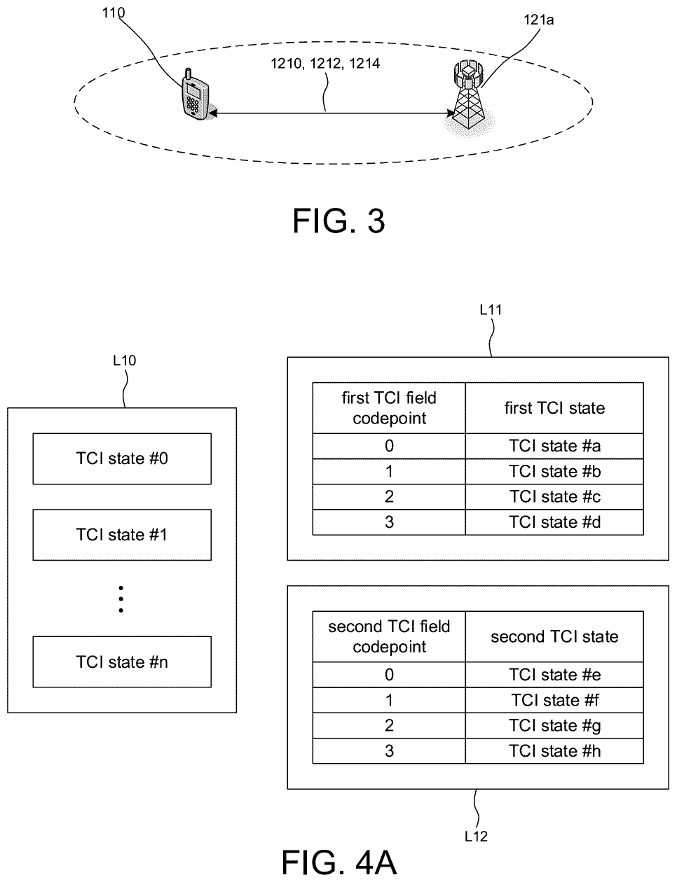

FIG. 3 illustrates one embodiment of message transmissions in accordance with one novel aspect. In general, the TRP 121a transmits a radio resource control (RRC) configuration 1210 of a control resource set (CORESET) or a PUCCH resource to the UE 110. The UE 110 receives the RRC configuration 1210 from the TRP 121a. The RRC configuration 1210 indicates to the UE 110 multiple transmission configuration indication (TCI) states.

The TRP 121a transmits an activation command 1212 (e.g., a MAC-CE) to the UE 110. The UE 110 receives the activation command 1212 from the TRP 121a. The activation command 1212 is used for the UE 110 to activate subsets of the multiple TCI states.

The TRP 121a transmits a downlink control information (DCI) 1214 to the UE 110. The UE 110 receives the DCI 1214 from the TRP 121a. The DCI 1214 indicates to the UE 110 to determine at least one TCI state from the subset(s) of the multiple TCI states as serving TCI(s).

In some embodiments, the RRC configuration 1210 indicates to the UE 110 multiple TCI states which is a general TCI state list associated with both DL reception and UL transmission. The activation command 1212 indicates to the UE 110 two subsets of the multiple TCI states. One of the subsets is a first list of active TCI states, which includes a plurality of first TCI states. The other of the subsets is a second list of active TCI states, which includes a plurality of second TCI states. Each of the first TCI states and the second states may be applied for DL reception and UL transmission.

In other words, after receiving the activation command 1212, the UE 110 determines the first TCI states and the second TCI states from the general TCI state list according to the activation command 1212.

More specifically, the UE 110 determines the first TCI states and the second TCI states from the general TCI state list by: (1) mapping the first TCI states to a plurality of first TCI field codepoints; and (2) mapping the second TCI states to a plurality of second TCI field codepoints. The first TCI field codepoints and the first TCI states may be one-to-one mapped. The second TCI field codepoints and the second TCI states may be one-to-one mapped.

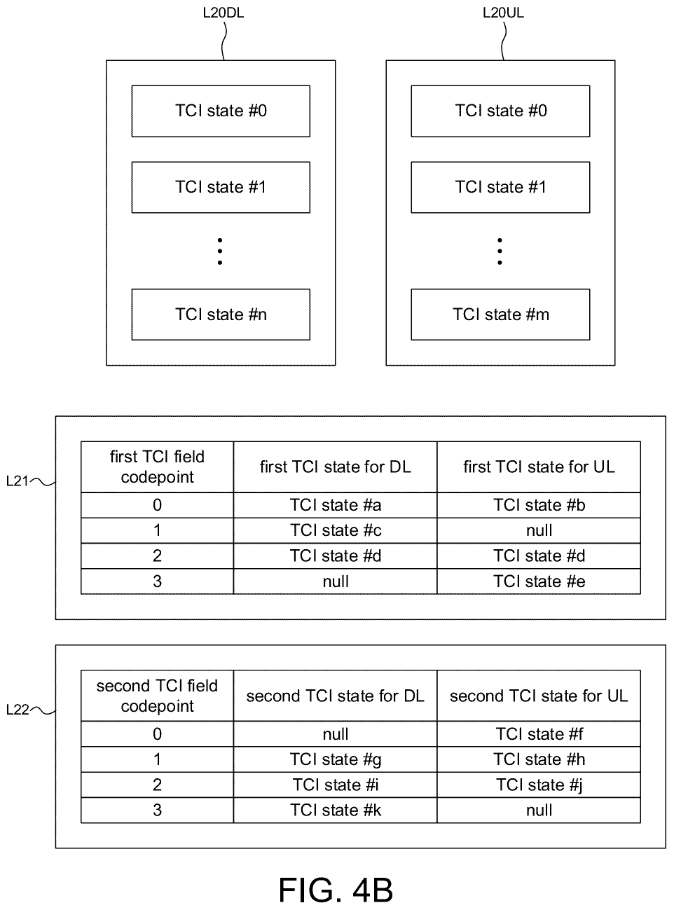

Please refer to FIG. 4A, which is an example of TCI states in accordance with one novel aspect. In particular, the RRC configuration 1210 indicates to the UE 110 the general TCI state list L10 associated with both DL reception and UL transmission. The activation command 1212 indicates to the UE 110 the first list L11 of active TCI states. The active TCI states recorded on the first list L11 are determined from the general TCI state list L10, and are the first TCI states ‘a’ to ‘d’. The activation command 1212 indicates to the UE 110 the second list L12 of active TCI states. The active TCI states recorded on the second list L12 are determined from the general TCI state list L10, and are the second TCI states ‘e’ to ‘h’.

According to the activation command 1212, the UE 110: (1) determines the first TCI states ‘a’ to ‘d’ mapped to the first TCI field codepoints ‘0’ to ‘3’ by the first list L11; and (2) determines the second TCI states ‘e’ to ‘h’ mapped to the second TCI field codepoints ‘0’ to ‘3’ by the second list L12.

In some embodiments, the DCI 1214 includes at least one TCI field for the UE 110 to determine the serving TCI(s) from the two subsets of TCI states (i.e., from the first TCI states and the second TCI states).

In some implementations, the DCI 1214 includes two TCI fields. The UE 110 determines: (1) a first serving TCI from the first TCI states according to one of the TCI fields; and (2) a second serving TCI from the second TCI states according to the other of the TCI fields.

More specifically, a value of the one of the TCI fields may correspond to a specific TCI field codepoint of the first TCI field codepoints, and a specific TCI state may be mapped to the specific TCI field codepoint. The UE 110 determines the specific TCI state as the first serving TCI. A value of the other of the TCI fields may correspond to another specific TCI field codepoint of the second TCI field codepoints, and another specific TCI state may be mapped to the other specific TCI field codepoint. The UE 110 determines the other specific TCI state as the second serving TCI.

For example, the value of the first TCI field of the DCI 1214 is ‘1’. The UE 110 determines, according to the first list L11, that the first TCI field corresponds to the first TCI field codepoint ‘1’ and the first TCI state ‘b’ is mapped to the first TCI field codepoint ‘1’. The UE 110 determines the TCI state ‘b’ as the first serving TCL The value of the second TCI field of the DCI 1214 is ‘0’. The UE 110 determines, according to the second list L12, that the second TCI field corresponds to the second TCI field codepoint ‘0’ mapped to the second TCI state ‘e’. The UE 110 determines the TCI state ‘e’ as the second serving TCI.

Then, the UE 110 may apply the first serving TCI to a DL reception or a UL transmission with one TRP. The UE 110 may apply the second serving TCI to a DL reception or a UL transmission with another TRP.

In some implementations, the DCI 1214 includes one TCI field. The UE 110: (1) determines the first serving TCI from the first TCI states according to the TCI field; or (2) the second serving TCI from the second TCI states according to the TCI field.

In some cases, when the DCI 1214 includes one TCI field and the DCI 1214 corresponds to a CORESET, the UE 110: (1) determines the first serving TCI from the first TCI states according to the TCI field when the CORESET is associated with the first serving TCI; or (2) determines the second serving TCI from the second TCI states according to the TCI field when the CORESET is associated with the second serving TCI.

More specifically, when: (1) the CORESET is associated with the first serving TCI, (2) a value of the TCI field corresponds to a specific TCI field codepoint of the first TCI field codepoints, and (3) a specific TCI state is mapped to the specific TCI field codepoint, the UE 110 determines the specific TCI state as the first serving TCI. When: (1) the CORESET is associated with the second serving TCI, (2) the value of the TCI field corresponds to another specific TCI field codepoint of the second TCI field codepoints, and (3) another specific TCI state is mapped to the other specific TCI field codepoint, the UE 110 determines the another specific TCI state as the first serving TCI.

For example, the value of the single TCI field of the DCI 1214 is ‘2’ and the DCI 1214 is associated with the first serving TCI. The UE 110 determines, according to the first list L11, that the single TCI field corresponds to the first TCI field codepoint ‘2’ and the first TCI state ‘c’ is mapped to the first TCI field codepoint ‘2’. The UE 110 determines the TCI state ‘c’ as the first serving TCI. The value of the single TCI field of the DCI 1214 is ‘3’ and the DCI 1214 is associated with the second serving TCI. The UE 110 determines, according to the second list L12, that the single TCI field corresponds to the second TCI field codepoint ‘3’ and the second TCI state ‘h’ is mapped to the second TCI field codepoint ‘3’. The UE 110 determines the TCI state ‘h’ as the second serving TCI.

In some cases, when the DCI 1214 includes one TCI field and an indicator indicating the UE 110 to determine the first serving TCI, the second serving TCI, or both the first serving TCI and the second serving TCI, the UE 110: (1) determines the first serving TCI from the first TCI states according to the TCI field when the indicator indicates the LE 110 to determine the first serving TCI; or (2) determines the second serving TCI from the second TCI states according to the TCI field when indicator indicates the UE 110 to determine the second serving TCI; or (3) determines both the first serving TCI from the first TCI states and the second serving TCI from the second TCI states according to the TCI field when indicator indicates the UE 110 to determine both the first serving TCI and the second serving TCI.

More specifically, when: (1) the indicator indicates the LE 110 to determine the first serving TCI, (2) a value of the TCI field corresponds to a specific TCI field codepoint of the first TCI field codepoints, and (3) a specific TCI state is mapped to the specific TCI field codepoint, the LE 110 determines the specific TCI state as the first serving TCI. When: (1) the indicator indicates the LE 110 to determine the second serving TCI, (2) the value of the TCI field corresponds to another specific TCI field codepoint of the second TCI field codepoints, and (3) another specific TCI state is mapped to the other specific TCI field codepoint, the LE 110 determines the another specific TCI state as the second serving TCI. When: (1) the indicator indicates the UE 110 to determine both the first serving TCI and the second serving TCI; (2) the value of the TCI field corresponds to the specific TCI field codepoint of the first TCI field codepoints and the another specific TCI field codepoint of the second TCI field codepoints, and (3) the specific TCI state is mapped to the specific TCI field codepoint and the another specific TCI state is mapped to the another specific TCI field codepoint, the LE 110 determines the specific TCI state as the first serving TCI and determines the another specific TCI state as the second serving TCI.

For example, the value of the single TCI field of the DCI 1214 is ‘0’ and the indicator of the DCI 1214 indicates the UE 110 to determine the first serving TCI. The UE 110 determines, according to the first list L11, that the single TCI field corresponds to the first TCI field codepoint ‘0’ and the first TCI state ‘a’ is mapped to the first TCI field codepoint ‘0’. The LE 110 determines the TCI state ‘a’ as the first serving TCL The value of the single TCI field of the DCI 1214 is ‘0’ and the indicator of the DCI 1214 indicates the UE 110 to determine the second serving TCI. The UE 110 determines, according to the second list L12, that the single TCI field corresponds to the second TCI field codepoint ‘0’ and the second TCI state ‘e’ is mapped to the second TCI field codepoint ‘0’. The UE 110 determines the TCI state ‘e’ as the second serving TCI. The value of the single TCI field of the DCI 1214 is ‘0’ and the indicator of the DCI 1214 indicates the UE 110 to determine the first serving TCI and the second serving TCI. The UE 110 determines: (1) according to the first list L11, that the single TCI field corresponds to the first TCI field codepoint ‘0’ and the first TCI state ‘a’ is mapped to the first TCI field codepoint ‘0’; and (2) according to the second list L12, that the single TCI field corresponds to the second TCI field codepoint ‘0’ and the second TCI state ‘e’ is mapped to the second TCI field codepoint ‘0’. The UE 110 determines the TCI state ‘a’ as the first serving TCI and the TCI state ‘e’ as the second serving TCI.

Then, the UE 110 may apply the first serving TCI to the DL reception or the UL transmission with one TRP if the first serving TCI is determined. The UE 110 may apply the second serving TCI to the DL reception or the UL transmission with another TRP if the second serving TCI is determined. The UE 110 may apply both the first serving TCI and the second serving TCI to the DL reception or the UL transmission with both TRPs if both the first serving TCI and second serving TCI are determined.

The indictor may be carried by an RRC configuration or in a DCI with DL assignment or UL grant.

In some embodiments, the RRC configuration 1210 indicates to the UE 110 a first part of the multiple TCI states and a second part of the multiple TCI states. The first part is a TCI state list associated with DL reception (i.e., DL TCI state list). The second part is a TCI state list associated with UL transmission (i.e., UL TCI state list). The activation command 1212 indicates to the UE 110 two subsets of TCI states. One of the subsets is a first list of active TCI states, which includes the first TCI states. The other of the subsets is a second list of active TCI states, which includes the second TCI states.

In other words, after receiving the activation command 1212, the UE 110: (1) determines the first TCI states from the DL TCI state list and the UL TCI state list according to the activation command 1212; and (2) determines the second TCI states from the DL TCI state list and the UL TCI state list according to the activation command 1212.

More specifically, the UE 110 determines the first TCI states from the DL TCI state list and the UL state list by mapping the first TCI states to a plurality of first TCI field codepoints while each of the first TCI field codepoints maps to one of the first TCI states for DL (i.e., one of the first TCI states selected from the DL TCI state list) and one of the first TCI states for UL (i.e., one of the first TCI states selected from the UL TCI state list). The UE 110 determines the second TCI states from the DL TCI state list and the UL state list by mapping the second TCI states to a plurality of second TCI field codepoints while each of the second TCI field codepoints maps to one of the second TCI states for DL (i.e., one of the second TCI states selected from the DL TCI state list) and one of the second TCI states for UL (i.e., one of the second TCI states selected from the UL TCI state list).

Please refer to FIG. 4B, which is an example of TCI states in accordance with one novel aspect. In particular, the RRC configuration 1210 indicates to the UE 110: (1) the DL TCI state list L20DL associated with DL reception; and (2) the UL TCI state list L20UL associated with UL transmission. The activation command 1212 indicates to the UE 110 the first list L21 of active TCI states. The active TCI states recorded on the first list L21 are determined from the DL TCI state list L20DL and the UL TCI state list L20UL, and are the first TCI states ‘a’, ‘c’, ‘d’ for DL and ‘b’, ‘d’, ‘e’ for UL. The activation command 1212 indicates to the UE 110 the second list L22 of active TCI states. The active TCI states recorded on the second list L22 are determined from the DL TCI state list L20DL and the UL TCI state list L20UL, and are the second TCI states ‘g’, ‘i’, ‘k’ for DL and ‘f’, ‘h’, ‘j’ for UL.

According to the activation command 1212, the UE 110: (1) determines the first TCI states ‘a’, ‘c’, ‘d’, ‘null’ for DL mapped to the first TCI field codepoints ‘0’ to ‘3’ and the first TCI states ‘b’, ‘null’, ‘d’, ‘e’ for UL mapped to the first TCI field codepoints ‘0’ to ‘3’ by the first list L21; and (2) determines the second TCI states ‘null’, ‘g’, ‘i’, ‘k’ for DL mapped to the second TCI field codepoints ‘0’ to ‘3’ and the second TCI states ‘f’, ‘h’, ‘j’, ‘null’ for UL mapped to the second TCI field codepoints ‘0’ to ‘3’ by the first list L22.

In some embodiments, the DCI 1214 includes at least one TCI field for the UE 110 to determine the serving TCI(s) from the two subsets of TCI states (i.e., from the first TCI states and the second TCI states).

In some implementations, the DCI 1214 includes two TCI fields. The UE 110 determines: (1) at least one first serving TCI from the first TCI states according to one of the TCI fields; and (2) at least one second serving TCI from the second TCI states according to the other of the TCI fields.

More specifically, a value of the one of the TCI fields may correspond to a specific TCI field codepoint of the first TCI field codepoints, and a specific DL TCI state and a specific UL TCI state may be mapped to the specific TCI field codepoint. The UE 110 determines the specific DL/UL TCI states as the first serving TCIs for DL/UL. A value of the other of the TCI fields may correspond to another specific TCI field codepoint of the second TCI field codepoints, and another specific DL TCI state and another specific UL TCI state may be mapped to the other specific TCI field codepoint. The UE 110 determines the other specific DL/UL TCI states as the second serving TCIs for DL/UL.

For example, the value of the first TCI field of the DCI 1214 is ‘0’. The UE 110 determines, according to the first list L21, that the first TCI field corresponds to the first TCI field codepoint ‘0’ and the first TCI state ‘a’ for DL and the first TCI state ‘b’ for UL are mapped to the first TCI field codepoint ‘0’. The UE 110 determines the TCI state ‘a’ as the first serving TCI for DL and the TCI state ‘b’ as the first serving TCI for UL. the value of the first TCI field of the DCI 1214 is ‘0’. The UE 110 determines, according to the second list L22, that the second TCI field corresponds to the second TCI field codepoint ‘1’ and the second TCI state ‘g’ for DL and the second TCI state ‘h’ for UL are mapped to the second TCI field codepoint ‘1’. The UE 110 determines the TCI state ‘g’ as the second serving TCI for DL and the TCI state ‘h’ as the second serving TCI for UL.

Then, the UE 110 may apply the first serving TCI for DL to a DL reception and apply the first serving TCI for UL to a UL transmission with one TRP. The UE 110 may apply the second serving TCI for DL to a DL reception and apply the second serving TCI for UL to a UL transmission with another TRP.

In some implementations, the DCI 1214 includes one TCI field. The UE 110: (1) determines the at least one first serving TCI from the first TCI states according to the TCI field; or (2) the at least one second serving TCI from the second TCI states according to the TCI field.

In some cases, when the DCI 1214 includes one TCI field and the DCI 1214 corresponds to a CORESET, the UE 110: (1) determines the at least one first serving TCI from the first TCI states according to the TCI field when the CORESET is associated with the at least one first serving TCI; or (2) determines the at least one second serving TCI from the second TCI states according to the TCI field when the CORESET is associated with the at least one second serving TCI.

More specifically, when: (1) the CORESET is associated with the at least one first serving TCI, (2) a value of the TCI field corresponds to a specific TCI field codepoint of the first TCI field codepoints, and (3) a specific DL TCI state and a specific UL TCI state is mapped to the specific TCI field codepoint, the UE 110 determines the specific DL/UL TCI states as the first serving TCIs for DL/UL. When: (1) the CORESET is associated with the second serving TCI, (2) the value of the TCI field corresponds to another specific TCI field codepoint of the second TCI filed codepoints, and (3) another specific DL TCI state and another specific UL TCI state is mapped to the other specific TCI field codepoint, the UE 110 determines the another specific DL/UL TCI states as the second serving TCI for DL/UL.

For example, the value of the single TCI field of the DCI 1214 is ‘2’ and the DCI 1214 is associated with the first serving TCI(s). The UE 110 determines, according to the first list L21, that the single TCI field corresponds to the first TCI field codepoint ‘2’ and the first TCI state ‘d’ for DL and UL is mapped to the first TCI field codepoint ‘2’. The UE 110 determines the TCI state ‘d’ as the first serving TCI for DL and UL. The value of the single TCI field of the DCI 1214 is ‘2’ and the DCI 1214 is associated with the second serving TCI(s). The UE 110 determines, according to the second list L22, that the single TCI field corresponds to the second TCI field codepoint ‘2’ and the second TCI state ‘i’ for DL and the second TCI state ‘j’ for UL is mapped to the second TCI field codepoint ‘2’. The UE 110 determines the TCI state ‘i’ as the second serving TCI for DL and the TCI state ‘j’ as the second serving TCI for UL.

In some cases, when the DCI 1214 includes one TCI field and an indicator indicating the UE 110 to determine the at least one first serving TCI, the at least one second serving TCI, or both the at least one first serving TCI and the at least one second serving TCI, the UE 110: (1) determines the at least one first serving TCI from the first TCI states according to the TCI field when the indicator indicates the UE 110 to determine the at least one first serving TCI; or (2) determines the at least one second serving TCI from the second TCI states according to the TCI field when indicator indicates the UE 110 to determine the at least one second serving TCI; or (3) determines both the at least one first serving TCI from the first TCI states and the at least one second serving TCI from the second TCI states according to the TCI field when indicator indicates the UE 110 to determine both the at least one first serving TCI the at least one second serving TCI.

More specifically, when: (1) the indicator indicates the UE 110 to determine the at least one first serving TCI, (2) a value of the TCI field corresponds to a specific TCI field codepoint of the first TCI field codepoints, and (3) a specific DL TCI state and a specific UL TCI stat are mapped to the specific TCI field codepoint e, the UE 110 determines the specific DL/UL TCI states as the first serving TCIs for DL/UL. When: (1) the indicator indicates the UE 110 to determine the at least one second serving TCI, (2) the value of the TCI field corresponds to another specific TCI field codepoint of the second TCI field codepoints, and (3) another specific DL TCI state and another specific UL TCI state are mapped to the another specific TCI field codepoint, the UE 110 determines the another specific DL/UL TCI states as the second serving TCIs for DL/UL. When: (1) the indicator indicates the UE 110 to determine both the at least one first serving TCI and the at least one second serving TCI, (2) the value of the TCI field corresponds to the specific TCI field codepoint of the first TCI field codepoints and the another specific TCI field codepoint of the second TCI field codepoints, and (3) the specific DL TCI state and the specific UL TCI state are mapped to the specific TCI field codepoint, and the another specific DL TCI state and the another specific UL TCI state are mapped to the another specific TCI field codepoint.

For example, the value of the single TCI field of the DCI 1214 is ‘0’ and the indicator of the DCI 1214 indicates the UE 110 to determine the first serving TCI(s). The UE 110 determines, according to the first list L21, that the single TCI field corresponds to the first TCI field codepoint ‘0’ and the first TCI state ‘a’ for DL and the first TCI state ‘b’ for UL are mapped to the first TCI field codepoint ‘0’. The UE 110 determines the TCI state ‘a’ as the first serving TCI for DL and the TCI state ‘b’ as the first serving TCI for UL. The value of the single TCI field of the DCI 1214 is ‘1’ and the indicator of the DCI 1214 indicates the UE 110 to determine the second serving TCI(s). The UE 110 determines, according to the second list L22, that the single TCI field corresponds to the second TCI field codepoint ‘1’ and the second TCI state ‘g’ for DL and the second TCI state ‘h’ for UL are mapped to the second TCI field codepoint ‘1’. The UE 110 determines the TCI state ‘g’ as the second serving TCI for DL and the TCI state ‘h’ as the second serving TCI for UL. The value of the single TCI field of the DCI 1214 is ‘2’ and the indicator of the DCI 1214 indicates the UE 110 to determine the first serving TCI(s) and the second serving TCI(s). The UE 110 determines: (1) according to the first list L21, that the single TCI field corresponds to the first TCI field codepoint ‘2’ and the first TCI state ‘d’ for DL and the first TCI state ‘d’ for UL are mapped to the first TCI field codepoint ‘2’; and (2) according to the second list L22, that the single TCI field corresponds to the second TCI field codepoint ‘2’ and the second TCI state ‘i’ for DL and the second TCI state ‘i’ for UL are mapped to the second TCI field codepoint ‘2’. The UE 110 determines: (1) the TCI state ‘d’ as the first serving TCI for DL and the TCI state ‘d’ as the first serving TCI for UL; and (2) the TCI state ‘i’ as the second serving TCI for DL and the TCI state ‘j’ as the second serving TCI for UL.

Then, the UE 110 may apply the first serving TCI for DL to the DL reception and apply the first serving TCI for UL to the UL transmission with one TRP if the first serving TCIs are determined. The UE 110 may apply the second serving TCI for DL to the DL reception and apply the second serving TCI for UL to the UL transmission with one TRP if the second serving TCIs are determined. The UE 110 may apply both the first serving TCI and the second serving TCI for DL to the DL reception and apply both the first serving TCI and the second serving TCI for UL to the UL transmission with both TRPs if both the first serving TCIs and the second serving TCIs are determined.

The indictor may be carried by an RRC configuration or in a DCI with DL assignment or UL grant.

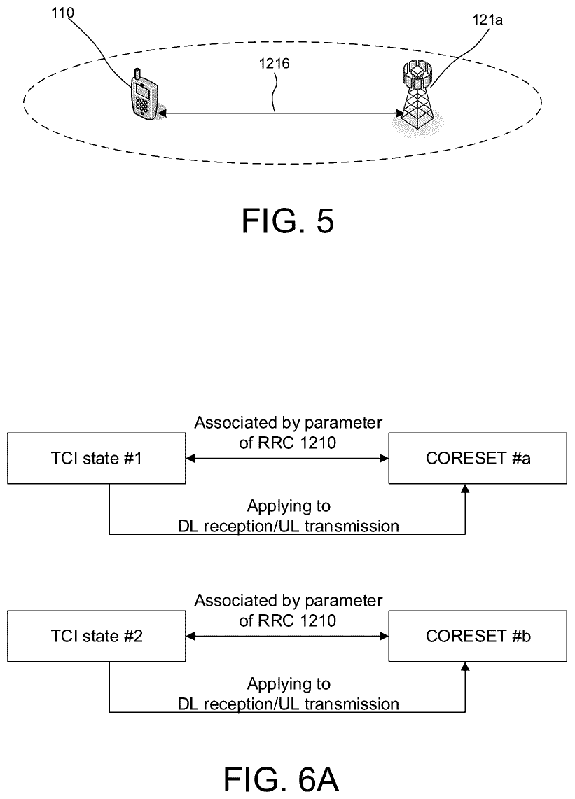

FIG. 5 illustrates one embodiment of message transmissions in accordance with one novel aspect. In some embodiments, the TRP 121a transmits at least one command 1216 to the UE 110. The UE 110 receives the at least one command 1216 from the TRP 121a. The at least one command 1216 indicates a plurality of serving TCIs. The UE 110 determines at least one of the serving TCIs according to at least one parameter in the RRC configuration 1210, and then applies the at least one of the serving TCIs to a PDCCH reception on the corresponding CORESET or a PUCCH transmission on the PUCCH resource.

In some embodiments, the serving TCIs include a first serving TCI and a second serving TCI. The UE 110 determines the first serving TCI, the second serving TCI, or both first and second serving TCIs according to the least one parameter in the RRC configuration.

In some implementations, the UE 110 applies the first serving TCI to the PDCCH reception on the CORESET or the PUCCH transmission on the PUCCH resource when the first serving TCI is determined by the UE according to the least one parameter in the RRC configuration.

In some implementations, the UE 110 applies the second serving TCI to the PDCCH reception on the CORESET or the PUCCH transmission on the PUCCH resource when the second serving TCI is determined by the UE according to the least one parameter in the RRC configuration.

In some implementations, the UE 110 applies both first and second serving TCIs to the PDCCH reception on the CORESET or the PUCCH transmission on the PUCCH resource when both first and second serving TCIs are determined by the UE according to the least one parameter in the RRC configuration.

In some embodiments, the at least one command 1216 is a DCI from the TRPa 121 and the DCI includes at least one TCI field indicating the plurality of serving TCIs. In some embodiments, the at least one command 1216 is a MAC-CE from the TRPa 121. In some embodiments, the at least one command 1216 indicates one of the serving TCIs, and the at least one command is received on a PDCCH, by the UE 110 applying the one of the serving TCIs.

In some embodiments, the least one parameter in the RRC configuration includes at least one index corresponding to one of the serving TCIs. In some embodiments, the at least one command indicates the one of the serving TCIs, and the at least one command is received on a PDCCH reception on a CORESET configured by the RRC configuration comprising the at least one index corresponding to the one of the serving TCIs.

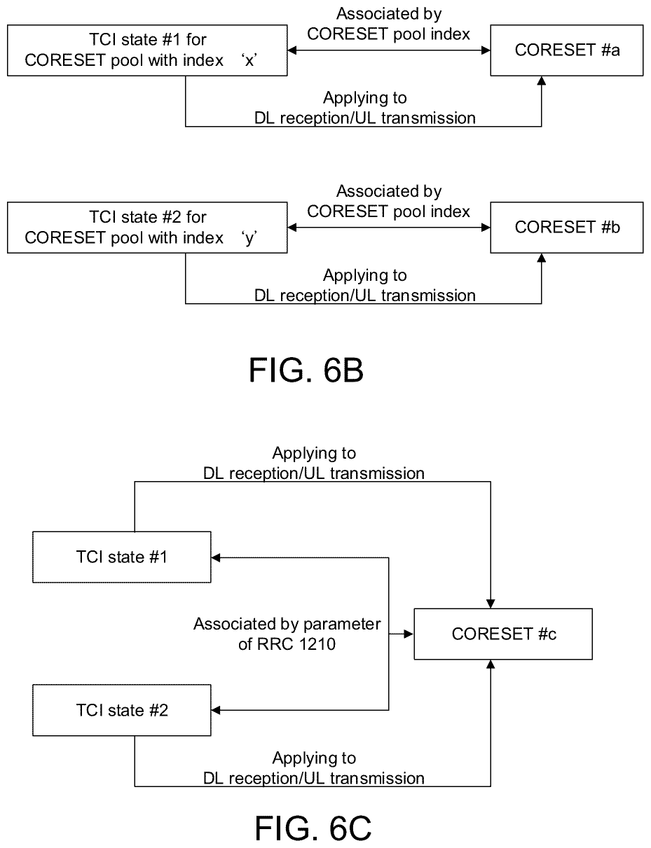

Please refer to FIG. 6A, which is an example of associations between serving TCIs and CORESETs in accordance with one novel aspect. In particular, when the UE 110 determines the first serving TCI ‘1’ according to parameters of the RRC configuration 1210, the UE 110 then applies the first serving TCI ‘1’ to the PDCCH reception on the CORESET ‘a’ or the PUCCH transmission on the PUCCH resource. When the UE 110 determines the second serving TCI ‘2’ according to parameters of the RRC configuration 1210, the UE 110 then applies the second serving TCI ‘2’ to the PDCCH reception on the CORESET ‘b’ or the PUCCH transmission on the PUCCH resource.

Please refer to FIG. 6B, which is an example of associations between serving TCIs and CORESETs in accordance with one novel aspect. In particular, when the UE 110 determines that the first serving TCI ‘1’ is configured to a first CORESET pool index ‘x’ according to parameter in the RRC configuration 1210, the UE 110 then applies the first serving TCI ‘1’ to the PDCCH reception on the CORESET ‘a’ belonged to the CORESET pool with index ‘x’ or the PUCCH transmission on the PUCCH resource. When the UE 110 determines that the second serving TCI ‘2’ is configured to a second CORESET pool index ‘y’ according to parameter in the RRC configuration 1210, the UE 110 then applies the second serving TCI ‘2’ to the PDCCH reception on the CORESET ‘b’ belonged to the CORESET pool with index ‘y’ or the PUCCH transmission on the PUCCH resource.

Please refer to FIG. 6C, which is an example of associations between serving TCIs and CORESETs in accordance with one novel aspect. In particular, when the UE 110 determines the first serving TCI ‘1’ and the second serving TCI ‘2’ according to parameter of the RRC configuration 1210. The UE 110 then applies both the first serving TCI ‘1’ and the second serving TCI ‘2’ to the PDCCH reception on the CORESET ‘c’ or the PUCCH transmission on the PUCCH resource.

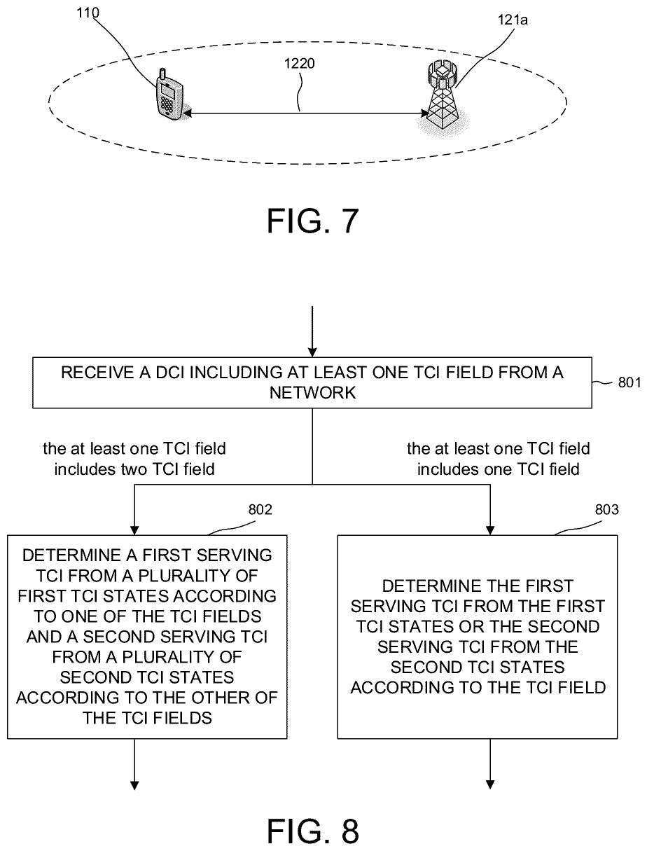

FIG. 7 illustrates one embodiment of message transmissions in accordance with one novel aspect. In some embodiments, the TRP 121a transmits a command to the UE 110. The command indicates a plurality of serving TCIs. The command may be carried by a DCI 1220, another DCI or a MAC-CE. The DCI 1220 schedules a DL reception or an UL transmission and includes a serving TCI indicator. The UE 110 receives the DCI 1220 from the TRP 121a. The UE 110 applies at least one of the serving TCIs to the DL reception or the UL transmission according to the serving TCI indicator in the DCI.

In some embodiments, the serving TCIs include a first serving TCI and a second serving TCI. The serving TCI indicator is one-bit. The UE 110 applies the first serving TCI to the DL reception or the UL transmission according to a value of the serving TCI indicator in the DCI 1220. The UE 110 applies the second serving TCI to the DL reception or the UL transmission according to the other value of the serving TCI indicator in the DCI 1220.

For example, the serving TCI indicator is one-bit. Value ‘0’ is for indicating an application of the first serving TCI ‘a’ and value ‘1’ is for indicating an application of the second serving TCI ‘b’. The UE 110 applies the first serving TCI ‘a’ to the DL reception or the UL transmission while the value of the serving TCI indicator is ‘0’. The UE 110 applies the second serving TCI ‘b’ to the DL reception or the UL transmission while the value of the serving TCI indicator is ‘1’.

In some embodiments, the serving TCIs include a first serving TCI and a second serving TCI. The serving TCI indicator is two-bit. The UE 110 applies the first serving TCI to the DL reception or the UL transmission according to a first value of the serving TCI indicator in the DCI 1220. The UE 110 applies the second serving TCI to the DL reception or the UL transmission according to a second value of the serving TCI indicator in the DCI 1220. The UE 110 applies both the first serving TCI and the second serving TCI to the DL reception or the UL transmission according to a third value of the serving TCI indicator in the DCI 1220.

For example, the serving TCI indicator is two-bit. Value ‘00’ is for indicating an application of the first serving TCI ‘a’, value ‘01’ is for indicating an application of the second serving TCI ‘b’ and value ‘10’ is for indicating an application of both the first serving TCI ‘a’ and the second serving TCI ‘b’. The UE 110 applies the first serving TCI ‘a’ to the DL reception or the UL transmission while the value of the serving TCI indicator is ‘00’. The UE 110 applies the second serving TCI ‘b’ to the DL reception or the UL transmission while the value of the serving TCI indicator is ‘01’. The UE 110 applies both the first serving TCI ‘a’ and the second serving TCI ‘b’ to the DL reception or the UL transmission while the value of the serving TCI indicator is ‘10’.

In some embodiments, the serving TCIs include a first serving TCI and a second serving TCI. The serving TCI indicator is two-bit. The UE 110 applies the first serving TCI to the DL reception or the UL transmission according to a first value of the serving TCI indicator in the DCI 1220. The UE 110 applies the second serving TCI to the DL reception or the UL transmission according to a second value of the serving TCI indicator in the DCI 1220.

The UE 110 applies, according to a first order, both the first serving TCI and the second serving TCI to the DL reception or the UL transmission according to a third value of the serving TCI indicator in the DCI 1220. The UE 110 applies, according to a second order, both the first serving TCI and the second serving TCI to the DL reception or the UL transmission according to a fourth value of the serving TCI indicator in the DCI 1220.

For example, the serving TCI indicator is two-bit. Value ‘00’ is for indicating an application of the first serving TCI ‘a’, value ‘01’ is for indicating an application of the second serving TCI ‘b’, value ‘10’ is for indicating an application of the first order of the first serving TCI ‘a’ and the second serving TCI ‘b’ and value ‘11’ is for indicating an application of the second order of the second serving TCI ‘b’ and the first serving TCI ‘a’.

The UE 110 applies the first serving TCI ‘a’ to the DL reception or the UL transmission while the value of the serving TCI indicator is ‘00’. The UE 110 applies the second serving TCI ‘b’ to the DL reception or the UL transmission while the value of the serving TCI indicator is ‘01’. The UE 110 applies the first serving TCI ‘a’ and the second serving TCI ‘b’ in the first order to the DL reception or the UL transmission while the value of the serving TCI indicator is ‘10’. The UE 110 applies the second serving TCI ‘b’ and the first serving TCI ‘a’ in the second order to the DL reception or the UL transmission while the value of the serving TCI indicator is ‘11’.

In some embodiments, the RRC 1210 includes a parameter indicating an activation of the serving TCI indicator in the DCI 1220. In other words, the UE 110 determines whether the serving TCI indicator is present in the DCI 1220 according to the parameter of the RRC 1210.

In some embodiments, the serving TCI indicator is enabled in the DCI 1220 when the CORESET corresponding to the DCI 1220 is associated with at least two of the serving TCIs.

In some embodiments, a number of bits of the serving TCI indicator corresponds to a number of the serving TCIs. For example, when there are 8 serving TCIs, the number of bits of the serving indicator is at least 3.

In some embodiments, the command includes a TCI field that indicates the plurality of serving TCIs, and the TCI field may be different from the serving TCI indicator.

FIG. 8 is a flow chart of a method for TCI for multiple-TRPs in accordance with one novel aspect. In step 801, a UE receives a DCI including at least one TCI field from a network. In step 802, when the at least one TCI field includes two TCI field, the UE determines a first serving TCI from a plurality of first TCI states according to one of the TCI fields and a second serving TCI from a plurality of second TCI states according to the other of the TCI fields. In step 803, when the at least one TCI field includes one TCI field, the UE determines the first serving TCI from the first TCI states or the second serving TCI from the second TCI states according to the TCI field.

In some embodiments, the at least one TCI field includes one TCI field and the DCI corresponds to a CORESET. The UE determines: (1) the first serving TCI from the first TCI states according to the TCI field when the CORESET is associated with the first serving TCI; or (2) determines the second serving TCI from the second TCI states according to the TCI field when the CORESET is associated with the second serving TCI.

In some embodiments, when the at least one TCI field includes one TCI field, the DCI further includes an indicator indicating the UE to determine the first serving TCI or the second serving TCI.

In some embodiments, the UE further receives a MAC-CE from the network, and determines the first TCI states and the second TCI states from a TCI state list according to the MAC-CE, wherein the TCI state list is associated with downlink reception and uplink transmission, and each of the first TCI states and the second states is for downlink reception and uplink transmission. The MAC-CE maps the first TCI states to a plurality of first TCI field codepoints, and maps the second TCI states to a plurality of second TCI field codepoints to. The first TCI field codepoints and the first TCI states are one-to-one mapped, and the second TCI field codepoints and the second TCI states are one-to-one mapped.

In some embodiments, the UE receives a MAC-CE from the network, and determines the first TCI states and the second TCI states from a first TCI state list and a second TCI state list according to the MAC-CE, wherein the first TCI state list is associated with downlink reception, and the second TCI state list is associated with uplink transmission. The MAC-CE maps the first TCIs states to a plurality of first TCI field codepoints, and maps the second TCIs states to a plurality of second TCI field codepoints. Each of the first TCI field codepoints maps to one of the first TCI states for downlink and/or one of the first TCI states for uplink. Each of the second TCI field codepoints maps to one of the second TCI states for downlink and/or one of the second TCI states for uplink.

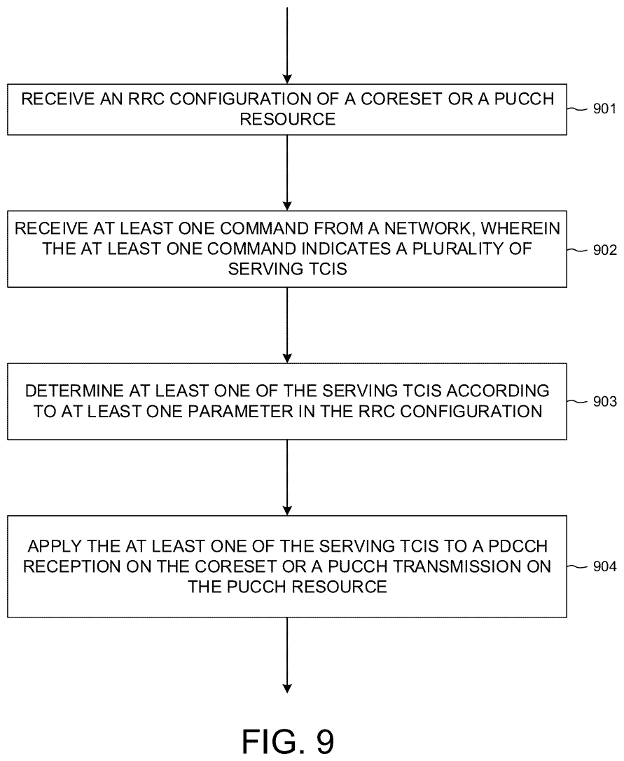

FIG. 9 is a flow chart of a method for TCI for multiple-TRPs in accordance with one novel aspect. In step 901, a UE receives an RRC configuration of a CORESET or a PUCCH resource. In step 902, the UE receives at least one command a network. The at least one command indicates a plurality of serving TCIs. In step 903, the UE determines at least one of the serving TCIs according to at least one parameter in the RRC configuration. In step 904, the UE applied the at least one of the serving TCIs to a PDCCH reception on the CORESET or a PUCCH transmission on the PUCCH resource.

In some embodiments, the serving TCIs include a first serving TCI and a second serving TCI. The UE determines the first serving TCI, the second serving TCI, or both first and second serving TCIs according to the least one parameter in the RRC configuration.

In some implementations, the UE applies the first serving TCI to the PDCCH reception on the CORESET or the PUCCH transmission on the PUCCH resource when the first serving TCI is determined by the UE according to the least one parameter in the RRC configuration.

In some implementations, the UE applies the second serving TCI to the PDCCH reception on the CORESET or the PUCCH transmission on the PUCCH resource when the second serving TCI is determined by the UE according to the least one parameter in the RRC configuration.

In some implementations, the UE applies both first and second serving TCIs to the PDCCH reception on the CORESET or the PUCCH transmission on the PUCCH resource when both first and second serving TCIs are determined by the UE according to the least one parameter in the RRC configuration.

In some embodiments, the at least one command is a DCI. In some embodiments, the DCI includes at least one TCI field indicating the plurality of serving TCIs. In some embodiments, the at least one command is a MAC-CE. In some embodiments, the at least one command indicates one of the serving TCIs, and the at least one command is received on a PDCCH, by the UE applying the one of the serving TCIs.

In some embodiments, the least one parameter in the RRC configuration includes at least one index corresponding to one of the serving TCIs. In some embodiments, the at least one command indicates the one of the serving TCIs, and the at least one command is received on a PDCCH reception on a CORESET configured by the RRC configuration comprising the at least one index corresponding to the one of the serving TCIs.

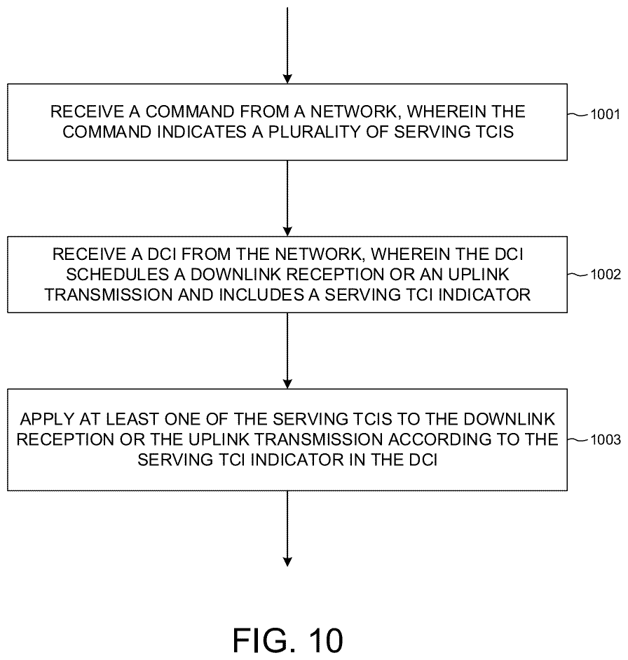

FIG. 10 is a flow chart of a method for TCI for multiple-TRPs in accordance with one novel aspect. In step 1001, the UE receives a command from a network. The command indicates a plurality of serving TCIs. In step 1002, the UE receives a DCI from the network. The DCI schedules a downlink reception or an uplink transmission and includes a serving TCI indicator. In step 1003, the UE applies at least one of the serving TCIs to the downlink reception or the uplink transmission according to the serving TCI indicator in the DCI.

In some embodiments, the serving TCIs include a first serving TCI and a second serving TCI. The serving TCI indicator is one-bit. The UE applies the first serving TCI to the downlink reception or the uplink transmission according to a value of the serving TCI indicator. The UE applies the second serving TCI to the downlink reception or the uplink transmission according to the other value of the serving TCI indicator.

In some embodiments, the serving TCIs include a first serving TCI and a second serving TCI. The serving TCI indicator is one-bit. The UE applies the first serving TCI or the second serving TCI to the downlink reception or the uplink transmission according to a value of the serving TCI indicator. The UE applies both the first serving TCI and the second serving TCI to the downlink reception or the uplink transmission according to the other value of the serving TCI indicator.

In some embodiments, the serving TCIs include a first serving TCI and a second serving TCI. The serving TCI indicator is two-bit. The UE applies the first serving TCI to the downlink reception or the uplink transmission according to a first value of the serving TCI indicator. The UE applies the second serving TCI to the downlink reception or the uplink transmission according to a second value of the serving TCI indicator. The UE applies both the first serving TCI and the second serving TCI to the downlink reception or the uplink transmission according to a third value of the serving TCI indicator.

In some embodiments, the serving TCIs include a first serving TCI and a second serving TCI. The serving TCI indicator is two-bit. The UE applies the first serving TCI to the downlink reception or the uplink transmission according to a first value of the serving TCI indicator. The UE applies the second serving TCI to the downlink reception or the uplink transmission according to a second value of the serving TCI indicator. The UE applies both the first serving TCI and the second serving TCI, in a first order, to the downlink reception or the uplink transmission in according to a third value of the serving TCI indicator. The UE applies both the first serving TCI and the second serving TCI, in a second order, to the downlink reception or the uplink transmission in according to a fourth value of the serving TCI indicator.

In some embodiments, the UE receives an RRC configuration. The RRC configuration indicates an activation of the serving TCI indicator in the DCI. In other words, the UE determines whether the serving TCI indicator is present in the DCI according to the RRC configuration.

In some embodiments, the serving TCI indicator is enabled in the DCI when the CORESET corresponding to the DCI is associated with at least two of the serving TCIs.

In some embodiments, a number of bits of the serving TCI indicator corresponds to a number of the serving TCIs.

In some embodiments, the command is carried by the DCI, another DCI or a MAC-CE from the network.

In some embodiments, the command includes a TCI field that indicates the plurality of serving TCIs, and the TCI field is different from the serving TCI indicator.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a user equipment (UE), a command from a network, wherein the command indicates a plurality of serving transmission configuration indications (TCIs);
receiving, by the UE, a downlink control information (DCI) from a network, wherein the DCI schedules a downlink reception or an uplink transmission and includes a serving TCI indicator;
applying, by the UE, at least one of the serving TCIs to the downlink reception or the uplink transmission according to the serving TCI indicator in the DCI.

2. The method of claim 1, wherein the serving TCIs include a first serving TCI and a second serving TCI, the serving TCI indicator is one-bit, and the step of applying the at least one of the serving TCIs to the downlink reception or the uplink transmission according to the serving TCI indicator in the DCI further comprises:
applying, by the UE, the first serving TCI to the downlink reception or the uplink transmission according to a value of the serving TCI indicator; or
applying, by the UE, the second serving TCI to the downlink reception or the uplink transmission according to the other value of the serving TCI indicator.

3. The method of claim 1, wherein the serving TCIs include a first serving TCI and a second serving TCI, the serving TCI indicator is one-bit, and the step of applying the at least one of the serving TCIs to the downlink reception or the uplink transmission according to the serving TCI indicator in the DCI further comprises:
applying, by the UE, the first serving TCI or the second serving TCI to the downlink reception or the uplink transmission according to a value of the serving TCI indicator; or
applying, by the UE, both the first serving TCI and the second serving TCI to the downlink reception or the uplink transmission according to another value of the serving TCI indicator.

4. The method of claim 1, wherein the serving TCIs include a first serving TCI and a second serving TCI, the serving TCI indicator is two-bit, and the step of applying the at least one of the serving TCIs to the downlink reception or the uplink transmission according to the serving TCI indicator in the DCI further comprises:
applying, by the UE, the first serving TCI to the downlink reception or the uplink transmission according to a first value of the serving TCI indicator;
applying, by the UE, the second serving TCI to the downlink reception or the uplink transmission according to a second value of the serving TCI indicator; or
applying, by the UE, both the first serving TCI and the second serving TCI to the downlink reception or the uplink transmission according to a third value of the serving TCI indicator.

5. The method of claim 1, wherein the serving TCIs include a first serving TCI and a second serving TCI, the serving TCI indicator is two-bit, and the step of applying the at least one of the serving TCIs to the downlink reception or the uplink transmission according to the serving TCI indicator in the DCI further comprises:
applying, by the UE, the first serving TCI to the downlink reception or the uplink transmission according to a first value of the serving TCI indicator;
applying, by the UE, the second serving TCI to the downlink reception or the uplink transmission according to a second value of the serving TCI indicator;
applying, by the UE, both the first serving TCI and the second serving TCI to the downlink reception or the uplink transmission with a first order according to a third value of the serving TCI indicator; or
applying, by the UE, both the first serving TCI and the second serving TCI to the downlink reception or the uplink transmission with a second order according to a fourth value of the serving TCI indicator.

6. The method of claim 1, further comprising:
receiving, by the UE, a radio resource control (RRC) configuration, wherein the UE determines whether the serving TCI indicator is present in the DCI according to the RRC configuration.

7. The method of claim 1, wherein the serving TCI indicator is enabled in the DCI when a control resource set (CORESET) corresponding to the DCI is associated with at least two of the serving TCIs.

8. The method of claim 1, wherein a number of bits of the serving TCI indicator corresponds to a number of the serving TCIs.

9. The method of claim 1, wherein the command is carried by the DCI, another DCI, or a media access control-control element (MAC-CE) from the network.

10. The method of claim 1, wherein the command includes a TCI field that indicates the plurality of serving TCIs, and the TCI field is different from the serving TCI indicator.

11. A user equipment (UE) comprising:
a transceiver that:
receives a command from a network, wherein the command indicates a plurality of serving transmission configuration indication (TCIs);
receives a downlink control information (DCI) from a network, wherein the DCI schedules a downlink reception or an uplink transmission and includes a serving TCI indicator; and
a transmission configuration indication (TCI) handling circuit that:
applies at least one of the serving TCIs to the downlink reception or the uplink transmission according to the serving TCI indicator in the DCI.

12. The UE of claim 11, wherein the serving TCIs include a first serving TCI and a second serving TCI, the serving TCI indicator is one-bit, and the TCI handling circuit further:
applies the first serving TCI to the downlink reception or the uplink transmission according to a value of the serving TCI indicator; or
applies the second serving TCI to the downlink reception or the uplink transmission according to another value of the serving TCI indicator.

13. The UE of claim 11, wherein the serving TCIs include a first serving TCI and a second serving TCI, the serving TCI indicator is one-bit, and the TCI handling circuit further:
applies the first serving TCI or the second serving TCI to the downlink reception or the uplink transmission according to a value of the serving TCI indicator; or
applies both the first serving TCI and the second serving TCI to the downlink reception or the uplink transmission according to another value of the serving TCI indicator.

14. The UE of claim 11, wherein the serving TCIs include a first serving TCI and a second serving TCI, the serving TCI indicator is two-bit, and the TCI handling circuit further:
applies the first serving TCI to the downlink reception or the uplink transmission according to a first value of the serving TCI indicator;
applies the second serving TCI to the downlink reception or the uplink transmission according to a second value of the serving TCI indicator; or
applies both the first serving TCI and the second serving TCI to the downlink reception or the uplink transmission according to a third value of the serving TCI indicator.

15. The UE of claim 11, wherein the serving TCIs include a first serving TCI and a second serving TCI, the serving TCI indicator is two-bit, and the TCI handling circuit further:
applies the first serving TCI to the downlink reception or the uplink transmission according to a first value of the serving TCI indicator;
applies the second serving TCI to the downlink reception or the uplink transmission according to a second value of the serving TCI indicator;
applies both the first serving TCI and the second serving TCI to the downlink reception or the uplink transmission with a first order according to a third value of the serving TCI indicator; or
applies both the first serving TCI and the second serving TCI to the downlink reception or the uplink transmission with a second order according to a fourth value of the serving TCI indicator.

16. The UE of claim 11, wherein the transceiver further:
receives a radio resource control (RRC) configuration, wherein the UE determines whether the serving TCI indicator is present in the DCI according to the RRC configuration.

17. The UE of claim 11, wherein the serving TCI indicator is enabled in the DCI when a control resource set (CORESET) corresponding to the DCI is associated with at least two of the serving TCIs.

18. The UE of claim 11, wherein a number of bits of the serving TCI indicator corresponds to a number of the serving TCIs.

19. The UE of claim 11, wherein the command is carried by the DCI, another DCI or a media access control-control element (MAC-CE) from the network.

20. The UE of claim 11, wherein the command includes a TCI field that indicates the plurality of serving TCIs, and the TCI field is different from the serving TCI indicator.
